(19) United States
(12) Patent Application Publication
(10) Pub. No.: US 2007/0171480 A1
(43) Pub. Date: Jul. 26, 2007

(54) Image processing device, image forming device, tint block image, printed material, image processing method, image forming method and program-recorded medium

(75) Inventor: Junichi Matsunoshita, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/491,154

(22) Filed: Jul. 24, 2006

(30) Foreign Application Priority Data
Jan. 25, 2006 (JP) 2006-015843

(51) Int. Cl. G06K 9/00

(52) U.S. Cl. 358/3.28; 382/100

(57) ABSTRACT

An image processing device includes a code image generating unit that generates a code image that contains plural patterns different in shape and represents predetermined information on the basis of positional relationship between adjacent patterns and a image composing unit that combines the code image generated by the code image generating unit and a document image.

### CROSS-REFERENCE TO RELATED APPLICATION

This application claims priority under 35 USC 119 from Japanese Patent Application No. 2006-15843 filed on Jan. 25, 2006, the disclosure of which is incorporated by reference herein.

### BACKGROUND

(1) Technical Field

The present invention relates to an image processing device for embedding information in an image and detecting the information from a printed material having the information embedded therein, an image forming device, a tint block image, a printed material, an image processing method, an image forming method and a program-recorded medium.

(2) Related Art

Recent propagation of personal computers, printers and copying machines has induced a problem of information leaks based on illegal copy of print-out confidential documents. In order to suppress the illegal copy of confidential documents, it is well known that when a confidential document is printed, a print (copy) is output while information on a user who is printing the confidential document, information on the date and hour of the printing, identification information of a device for outputting the print, etc. (hereinafter referred to as trace information) is embedded in the print (copy), and afterwards the image of the print-out original is read by a scanner or the like to analyze the information on the user, the client PC, the printer, the date and hour, etc. embedded in the read image, thereby estimating an information leakage source.

According to the method of preventing the information leaks as described above, it is required to surely read out trace information embedded in a document. Furthermore, it is required to read out trace information not only from an original manuscript having trace information which is embedded at the print-out time, but also from a copy achieved from the original manuscript by using a copying machine.

### SUMMARY

According to an aspect of the present invention, there is provided an image processing device including: a code image generating unit that generates a code image that contains plural patterns different in shape and represents predetermined information on the basis of positional relationship between adjacent patterns; and an image composing unit that combines the code image generated by the code image generating unit and a document image.

### BRIEF DESCRIPTION OF THE DRAWINGS

Exemplary embodiments of the present invention will be described in detail based on the following figures, wherein:

FIGS. 1A and 1B are diagrams showing a method of embedding trace information according to an image processing device of an exemplary embodiment of the present invention, wherein FIG. 1A shows a printed original manuscript, and FIG. 1B shows a copy image copied from the original manuscript;

FIG. 2 shows an image forming system 1 containing an image forming device 10;

FIG. 3 is a diagram showing the hardware construction of an image processing device 2 to which an image processing method according to another exemplary embodiment of the invention is applied while concentrating on a controller 20;

FIG. 4 is a diagram showing the functional construction of an image processing program 4 that is executed by the controller 20 and implements the image processing method of the exemplary embodiment of the invention;

FIG. 5 is a diagram showing the details of a tint block image generator 46;

FIGS. 6A and 6B are diagrams showing a first code and a second code, wherein FIG. 6A shows a first code generated by a first encoder 460, and FIG. 6B shows a second code generated by a second encoder 464;

FIGS. 7A to 7C each is a diagram showing a pattern that is stored in a pattern memory 468 and is referred to by a pattern image generator 466;

FIGS. 8A to 8C are diagrams showing a method of adjusting the pattern position by a pattern position modulator 470, wherein FIG. 8A shows a pattern pair comprising adjacent patterns, and FIGS. 8B and 8C show pattern pairs for which the distance between the patterns is adjusted by the pattern position modulator 470;

FIGS. 9A to 9C are diagrams showing printed material on which a background tint block image generated by the image processing device 2 is printed, wherein FIG. 9A shows a printed material having the background tint block image printed thereon, FIG. 9B shows a copy manuscript achieved by copying the printed material, and FIG. 9C is diagram showing the background tint block image in which an area S in FIG. 9A is enlarged;

FIG. 10 is a flowchart showing background tint block image generating processing (S10) by an image processing program 4;

FIG. 11 is a flowchart showing print processing (S20) by an image forming device 10;

FIG. 12 is a diagram showing the details of a trace information detector 56;

FIG. 13 is a diagram showing the details of a first code decoder 566;

FIGS. 14A to 14D are diagrams showing Hough transformation carried out by a skew angle detector 574, wherein FIG. 4A shows image data (pattern data) stored in a buffer memory 572, FIG. 14B shows a Hough space after all the patterns are subjected to Hough transformation, FIG. 14C shows a projection distribution on the angle θ axis, and FIG. 14D shows the waveform in the distance ρ direction on the angle θ skew;

FIG. 15 is a flowchart showing first trace information decoding processing (S30) by a first code decoder 566;

FIG. 16 is a diagram showing the details of a second code decoder 568;

FIG. 17 is a flowchart showing second trace information decoding processing (S40) by a second code decoder 568;

FIG. 18 is a flowchart showing trace information detection processing (S50) by the image processing device 2;

FIG. 19 is a diagram showing the details of a tint block image generator 66;

FIGS. 20A and 20B are diagrams showing a first word arrangement and a second bit arrangement, wherein FIG. 20A shows the first word arrangement generated by a first encoder 660, and FIG. 20B shows the second bit arrangement generated by a second encoder 664;

FIGS. 21A to 21H each is a diagram showing a pattern that is stored in a code pattern memory 668 and referred to by a pattern image generator 666;

FIG. 22 is a flowchart showing background tint block image generating processing (S60) by an image processing program 4 executed on the image processing device 2 according to a second exemplary embodiment;

FIG. 23 is a diagram showing the details of a trace information detector 76;

FIG. 24 is a flowchart showing first trace information decoding processing (S70) of a first code decoder 766; and

FIG. 25 is a flowchart showing second trace information decoding processing (S80) of a second code decoder 768.

### DETAILED DESCRIPTION

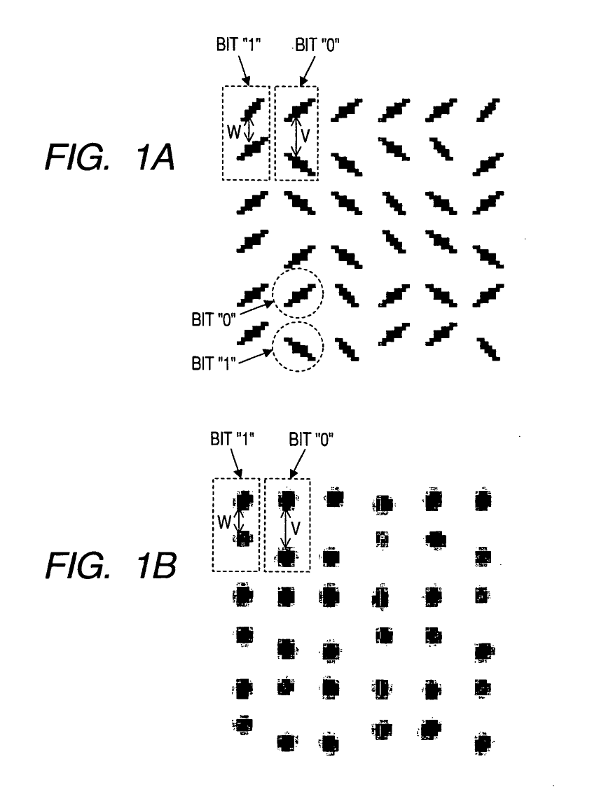

FIGS. 1A and 1B are diagrams showing a method of embedding trace information by an image processing device according to an exemplary embodiment of the present invention. In detail, FIG. 1A shows a printed original manuscript, and FIG. 1B shows a copy image of the original manuscript.

As shown in FIG. 1A, the image processing device of the exemplary embodiment generates a pattern image in which plural minute patterns are arranged, and embeds information containing trace information on the basis of positional relationship between the adjacent minute patterns.

The patterns are arranged in the grid form, and the information is embedded by displacing each pattern in at least one of the vertical (up-and-down) direction and the horizontal (right-and-left) direction. Alternatively, the information may be embedded by setting every two adjacent patterns as a set (pair) and fixing one pattern of each set (pair) while the other pattern is displaced in at least one of the vertical direction and the horizontal direction. The moving direction of the patterns, the positional relationship of the patterns to be paired and the number of patterns contained in each set are not limited to this exemplary embodiment.

For example, in FIG. 1A, adjacent patterns in the vertical direction are set as a pair, and patterns at odd-numbered stages (each pattern located at the upper side of each pair) out of the plural patterns arranged in the grid form are fixed, and patterns at even-numbered stages (each patter located at the lower side of each pair) are moved in the vertical direction, whereby information is embedded in connection with the positional relationship between two patterns contained in each pair. In this exemplary embodiment, when the distance between the two patterns is longer as indicated by an arrow v in FIG. 1A, the pair of the patterns represents a bit “0”, and when the distance between the two patterns is shorter as indicated by an arrow w, the pair of the patterns represents a bit “1”.

According to the image processing device of this exemplary embodiment of the present invention, information is further embedded on the basis of the shape of each minute pattern. In this exemplary embodiment, a pattern inclined to the upper right side represents a bit “0”, and a pattern inclined to the lower right side represents a bit “1”.

Furthermore, according to the image processing device of this exemplary embodiment of the present invention, a pattern is prevented from being vanished at the copy time by adjusting the thickness (background density) of the pattern. The image processing device maybe designed so that information which is more required to be left (for example, trace information) even when it is copied is embedded on the basis of the positional relationship of patterns, and other information (for example, copy permission condition) is embedded in the shape of the patterns.

In a case where information is embedded in a document as described above, even when the document is copied and the shape of patterns is broken as shown in FIG. 1B, at least the embedded information can be detected on the basis of the positional relationship of the patterns. Accordingly, resistance to copy can be enhanced. Furthermore, according to the image processing device of this exemplary embodiment, the shape of a pattern, the position in the vertical direction of the pattern and the position in the horizontal direction of the pattern, that is, at least three information can be embedded for one pattern, so that the information capacity to be embedded can be increased. Furthermore, even when information is embedded on the basis of only the shape of patterns, the information concerned can be detected, so that compatibility is established.

Next, an image forming system according to an exemplary embodiment of the present invention will be described.

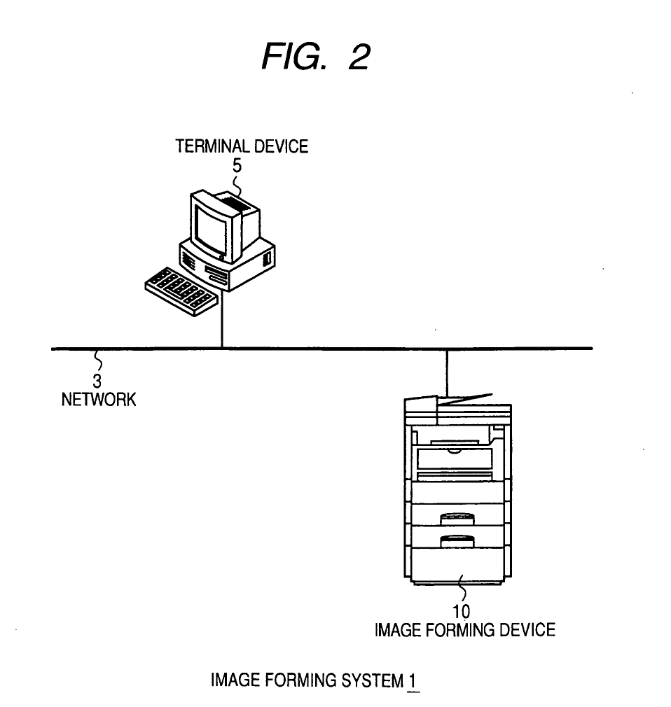

FIG. 2 shows an image forming system 1 containing an image forming device 10.

As shown in FIG. 2, the image forming system 1 contains the image forming device 10 and a terminal device 5 such as a personal computer (PC) or the like which are connected to each other through a network 3.

The terminal device 5 displays an image on a CRT display device or a liquid crystal display device and transmits the data of the image concerned to the image forming device 10 to request printing. In place of the personal computer, another type terminal device having a communication device for receiving/transmitting signals through a network 3 may be used as the terminal device 5. The network 3 may be constructed in a wired style or wireless style. Furthermore, plural terminal devices 5 and the image forming device 10 may be connected to the network 3.

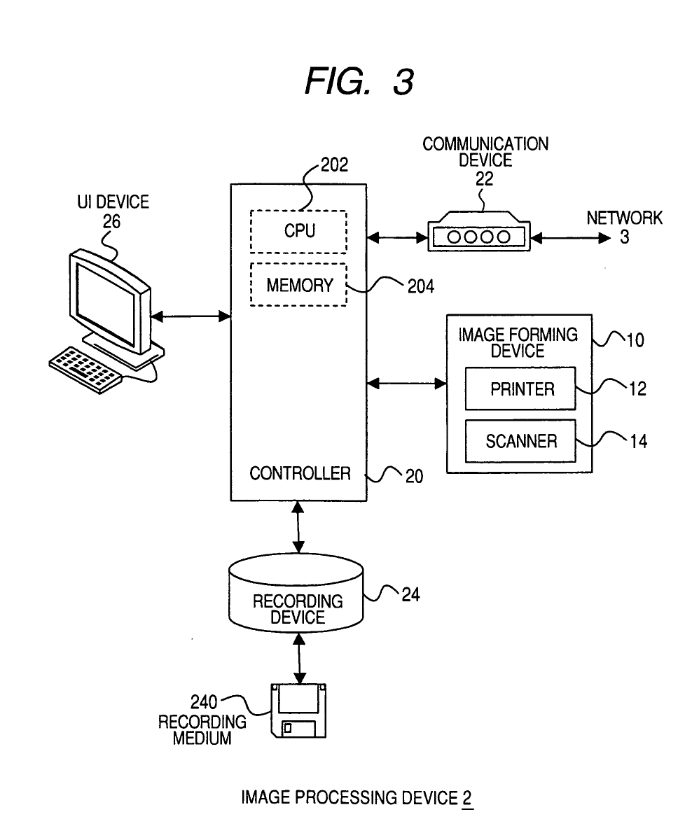

FIG. 3 is a diagram showing the hardware construction of the image processing device 2 to which an image processing method according to an exemplary embodiment of the invention is applied while concentrating on a controller 20.

As shown in FIG. 3, the image forming device 10 has a printer 12, a scanner 14 an the image processing device 2. The printer 12 prints and records, on a sheet, image data which have been subjected to predetermined image processing by the image processing device 2 under the control of the controller 20, and then outputs the sheet having the image data recorded thereon. Under the control of the controller 20, the scanner 14 reads out an original put on a platen, and outputs the image data to the image processing device 2.

The image processing device 2 is equipped with the controller 20 having CPU 202, a memory 204, etc., a communication device 22 for receiving/transmitting data through the network 3, a recording device 24 such as HDD, CD or DVD device, a user interface device (UI device) 26 that contains an LCD display device or CRT display device, a keyboard or touch panel, etc. and accepts an operation from a user. The image processing device 2 is a general-purpose computer in which an image processing program 4 described later is installed, for example.

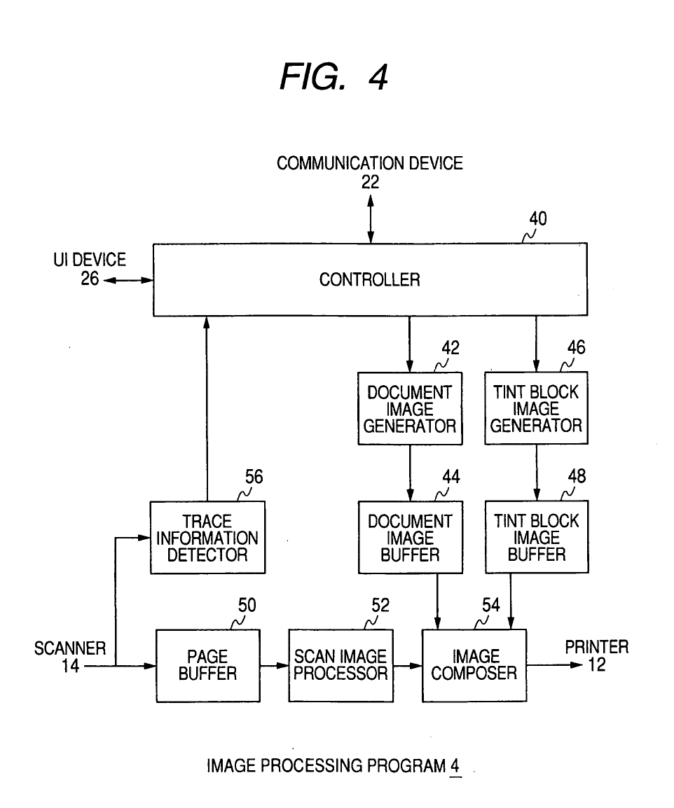

FIG. 4 is a diagram showing the functional construction of the image processing program 4 that is executed by the controller 20 and implements the image processing method according to the exemplary embodiment of the present invention.

As shown in FIG. 4, the image processing program 4 contains a controller 40, a document image generator 42, a document image buffer 44, a tint block image generator 46, a tint block image buffer 48, a page buffer 50, a scan image processor 52, an image composer 54 and a trace information detector 56. The function of the whole or a part of the image processing program 4 may be implemented by hardware such as ASIC or the like which is provided to the image forming device 10.

According to the above-described construction, the image processing program 4 generates a code image that contains plural patterns different in shape and represents predetermined information on the basis of positional relationship between adjacent patterns, and combines the thus-generated code image and a document image. The image processing program 4 detects plural patterns contained in an image read by the image forming device 10, and detects the information on the basis of the positional relationship between adjacent patterns out of the plural detected patterns.

In the image processing program 4, the controller 40 controls the printer 12, the scanner 14 and the other constituent elements. Furthermore, the controller 40 receives/transmits the data through the communication device 22, accepts an operation from a user through the UI device 26, outputs data to each constituent element and displays an output result of each constituent element on the UI device 26. More specifically, the controller 40 accepts through the communication device 22 document data of a print target which are transmitted from the terminal device 5 through the network 3. Here, the document data are set in a PDL (Print Description Language) format.

Furthermore, the controller 40 displays information (trace information, etc.) detected by a trace information detector 56 described later on the UI device 26. Furthermore, the controller 40 extracts a job log ID from the detected trace information. When the extracted job log ID exists in job log data in the image forming device 10, the controller 40 displays the data concerned and the document image data associated with the job log ID concerned or a thumb nail thereof on the UI device 26.

The document image generator 42 carries out drawing processing on PDL-format document data input from the controller 40 to generate document image data. More specifically, the document image generator 42 makes an interpretation of PDL and carries out development (rasterization)into YMCK full-color image data. The document image generator 42 stores the rasterized document image data into the document image buffer 44.

The document image buffer 44 stores the document image data generated by the document image generator 42. The document image buffer 44 is implemented by a memory, a hard disk drive or the like.

The tint block image generator 46 is controlled by the controller 40 to generate background tint block image data, and stores the background tint block image data thus generated into the tint block image buffer 48. More specifically, when a background tint block image composing mode is preset by a manager or the like, the tint block image generator 46 generates a background tint block image on the basis of additional information set by the controller 40. For example, the background tint block image data are binary image data, and the resolution of the background tint block image is equal to the resolution of the printer 12 (for example, 600 dpi).

The additional information contains trace information and preset latent image information. The trace information contains first trace information and second trace information, and the latent image information contains latent image character array information, latent image picture information, gradation value information, etc. The first trace information contains a transmission source IP address, a transmission source PC client's name, a transmission source user's name and a document's name which are added to a header of transmitted document data, an image forming device identifier ID allocated every image forming device, copy prohibition/permission information preset by a manager or the like, and an output starting date and hour achieved from a timer in the controller 40, for example. The second trace information contains a unique job log ID allocated when a print job is accepted. An image having the second trace information embedded therein is uniquely identified on the basis of the job log ID. The second trance information may contain at least a part of at least the first trace information.

The background tint block image generation processing will be described later.

The tint block image buffer 48 stores the background tint block image data generated by the tint block image generator 46. The tint block image buffer 48 is implemented as in the case of the document image buffer 44.

When the background tint block image composing mode is preset by the manager or the like, the image composer 54 reads out a document image and a background tint block image from the document image buffer 44 and the tint block image buffer 48 respectively in synchronism with the printer 12, conducts logical addition (combination) on the background tint block image and the color components in which the document image is set, and outputs the composite result to the printer 12. Furthermore, the image composer 54 accepts image data input from the scanner 14 through the scan image processor 52 described later, combines this image with the background tint block image and then outputs the composite result to the printer 12. When a background tint block non-composing mode is set, the image composer 54 reads out the document image from the document image buffer 44 in synchronism with the printer 12, and outputs the document image to the printer 12.

The trace information detector 56 accepts the image data read by the scanner 14, detects information (containing trace information) embedded in the image and then outputs the information concerned to the controller 40. When no information is detected from the image, the trace information detector 56 notifies this fact to the controller 40. An information detecting method will be described later.

The page buffer 50 stores the image data read by the scanner 14. The page buffer 50 is implemented as in the case of the document image buffer 44.

The scan image processor 52 is controlled by the controller 40 to read out an image from the page buffer 50 at a predetermined timing, subject the image concerned to image processing such as color conversion processing, gradation correcting processing, etc., and then outputs the processed image to the image composer 54.

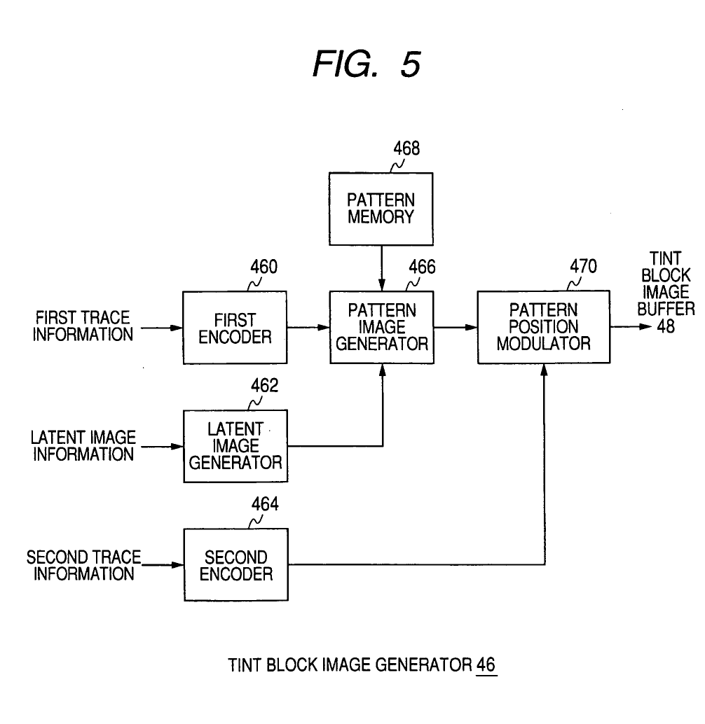

FIG. 5 is a diagram showing the details of the tint block image generator 46.

As shown in FIG. 5, the tint block image generator 46 contains a first encoder 460, a latent image generator 462, a second encoder 464, a pattern image generator 466, a pattern memory 468 and a pattern position modulator 470. The tint block image generator 46 constitutes a code image generating unit for generating a code image (that is, background tint block image) that contains plural patterns different in shape and represents predetermined information on the basis of the positional relationship between the adjacent patterns.

The latent image generator 462 generates a latent image on the basis of latent image information input from the controller 40. The latent image information indicates what latent image character or the like should be embedded in a pattern image. More specifically, the latent image contains the character array of the latent image, the font type, the font size, the direction (angle) of the character array of the latent image, etc. When receiving the latent image information, the latent image generator 462 draws the character array of the latent image in the indicated direction on the basis the indicated font type and font size, and generates a binary latent image. The resolution of the latent image corresponds to the resolution achieved by dividing the resolution of the printer by the pattern size. For example, when the printer resolution is equal to 600 dpi and the pattern size is set to 12 pixels×12 pixels, the resolution of the latent image is equal to 50 dpi. The latent image generator 462 outputs the latent image thus generated to the pattern image generator 466.

The first encoder 460 executes error-correcting coding on the input first trace information, and two-dimensionally arranges a bit array after the error-correcting encoding is executed, thereby generating a bit array of a predetermined size having an arrangement of bits 0 and bits 1 (first code). The first encoder 460 repetitively arranges the thus-generated first code in the longitudinal and lateral directions to generate a bit array (first bit arrangement) having the same size as the latent image generated by the latent image generator 462. The first encoder 460 further outputs the first bit arrangement thus generated to the pattern image generator 466. The first code will be described in detail later.

The second encoder 464 executes error-correcting coding on the input second trace information, and two-dimensionally arranges a bit array after the error-correcting coding is executed, thereby generating a code having an arrangement of bits 0 and bits 1 (second code). Furthermore, the second encoder 464 repetitively arranges the thus-generated second code in the longitudinal and lateral directions to generate a bit arrangement (second bit arrangement) having the same size as the latent image. The second encoder 464 further outputs the thus-generated second bit arrangement to the pattern position modulator 470. The second code will be described in detail later.

The pattern image generator 466 generates a pattern image on the basis of the latent image generated by the latent image generator 462, the first bit arrangement generated by the first encoder 460 and a pattern stored in the pattern memory 468, which will be described later. The pattern image generator 466 outputs the thus-generated pattern image to the pattern position modulator 470. The pattern image generating processing will be described in detail later.

On the basis of the second bit arrangement generated by the second encoder 464, the pattern position modulator 470 adjusts positional relationship between adjacent patterns of the pattern image generated by the pattern image generator 466, and generates a background tint block image. At this time, the pattern position modulator 470 adjusts the distance between the adjacent patterns in the vertical (up-and-down) direction. Alternatively, the pattern position modulator 470 may adjust distance between the adjacent patterns in the horizontal (right-and-left) direction. Here, one bit of the second bit arrangement corresponds to a pair of two patterns (for example, 12 pixels×24 pixels) adjacent in the vertical direction in the pattern image. The pattern position modulator 470 stores the generated background tint block image into the tint block image buffer 48. A method of adjusting the pattern position will be described in detail later.

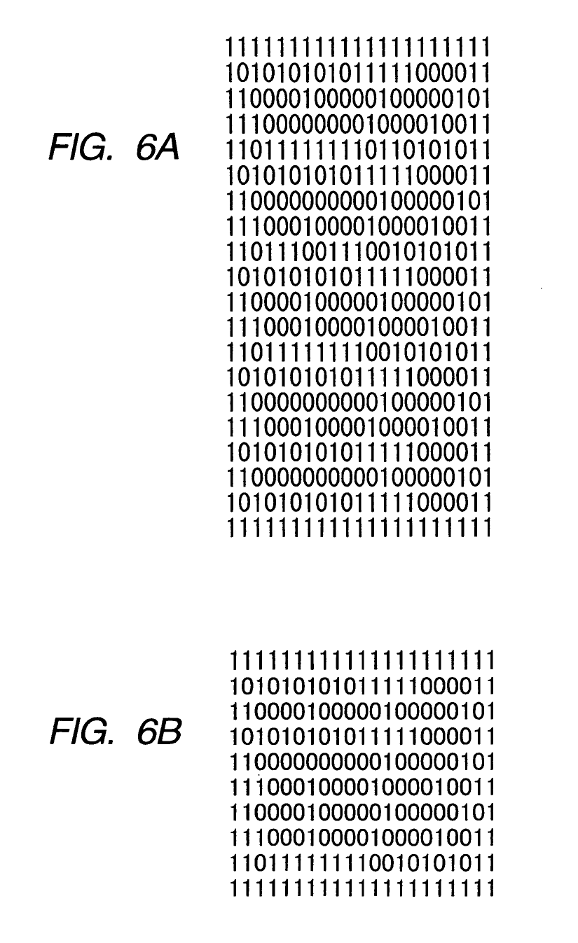

FIGS. 6A and 6B are diagrams showing examples of the first code and the second code, wherein FIG. 6A shows the first code generated by the first encoder 460, and FIG. 6B shows the second code generated by the second encoder 464.

As shown in FIG. 6A, the first code is a bit arrangement having “0” and “1”. In the first code, each bit on the outer periphery of the first code is a synchronous bit (synchronous code) representing the cut-out position of the first code at the time when information is detected, and all the bits are set to “1”, for example.

As shown in FIG. 6B, the second code is also a bit arrangement having “0” and “1”. In the second code, each bit on the periphery of the second code is likewise a synchronous bit representing the cut-out position of the second code at the time when information is detected, and all the bits are set to “1”, for example. In this exemplary embodiment, the size in the longitudinal direction of the second code is set to a half of that of the first code.

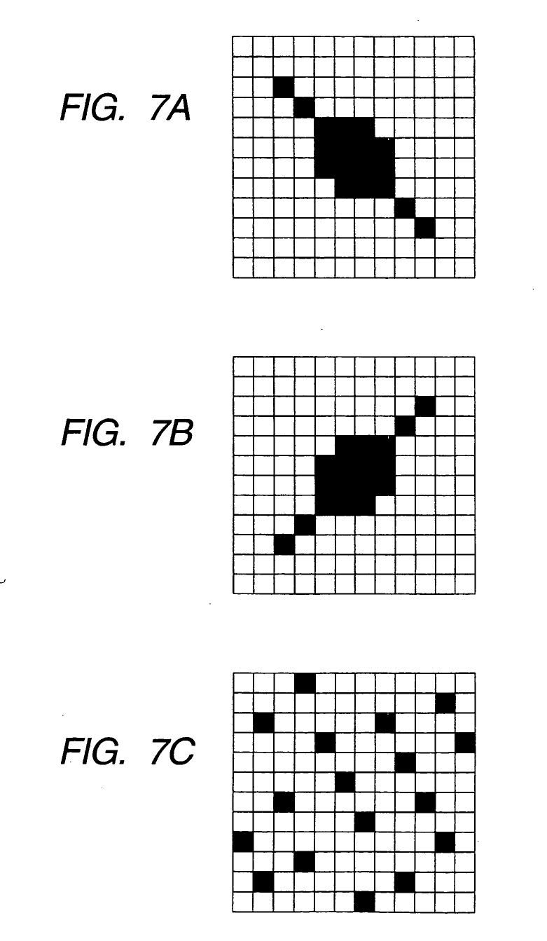

FIGS. 7A to 7C are diagrams showing patterns stored in the pattern memory 468 and referred to by the pattern image generator 466.

The pattern image generator 466 successively refers to the latent image and the first bit arrangement from the upper left side, for example, and selects any one of patterns (FIGS. 7A to 7C) stored in the pattern memory 468 on the basis of the pixel value of the latent image and the bit value of the first bit arrangement, whereby the formation of the pattern image progresses.

Here, when the latent image is a white pixel and the bit value of the first bit arrangement is equal to 1, the pattern shown in FIG. 7A is selected. When the latent image is a white pixel and the bit value of the first bit arrangement is equal to 0, the pattern shown in FIG. 7B is selected. Furthermore, when the latent image is a black pixel, the pattern shown in FIG. 7C is selected.

The pattern image thus generated is as follows. That is, a character portion of the latent image is converted to an isolated dot pattern (FIG. 7C), and a background portion of the latent image is converted to an inclined pattern (FIGS. 7A and 7B) corresponding to the bit value (0 or 1) of the first code. Therefore, the pattern image is generated so that one pixel of the latent image corresponds to one pattern of 12 pixels×12 pixels. Accordingly, the resolution of the pattern image is coincident with the resolution of the printer. For example, when the latent image has a resolution of 500 dpi, the pattern image has a resolution of 50 dpi×12 pixels=600 dpi. As described above, the pattern image generator 466 arranges plural patterns different in shape, thereby constituting a pattern arrangement unit.

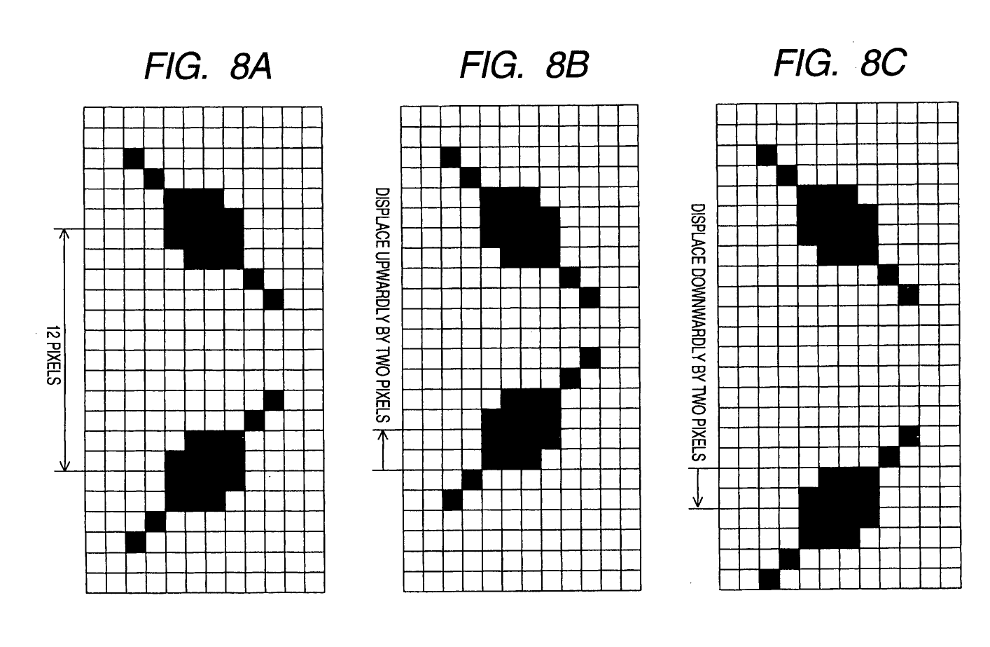

FIGS. 8A to 8C are diagrams showing the method of adjusting the pattern position of the pattern position modulator 470, wherein FIG. 8A shows a pattern pair including adjacent patterns, and FIGS. 8B and 8C show pattern pairs for which the distance between patterns is adjusted by the pattern position modulator 470.

The pattern position modulator 470 successively refers to the bit value of the second bit arrangement from the upper left side, for example. In the pattern pair of the pattern image corresponding to the position of a bit which is referred to, for example, the position of the lower pattern is displaced in any one of the upward and downward directions by the amount corresponding to a predetermined number of pixels.

Here, when the bit value of the second code is equal to 1, the lower pattern is upwardly displaced by the amount corresponding to two pixels as shown in FIG. 8B.

When the bit value of the second code is equal to 0, the lower pattern is downwardly displaced by the amount corresponding to two pixels as shown in FIG. 8C.

As described above, the pattern position modulator 470 adjusts the positional relationship between the adjacent patterns arranged by the pattern image generator 466, and constitutes the pattern position adjusting unit.

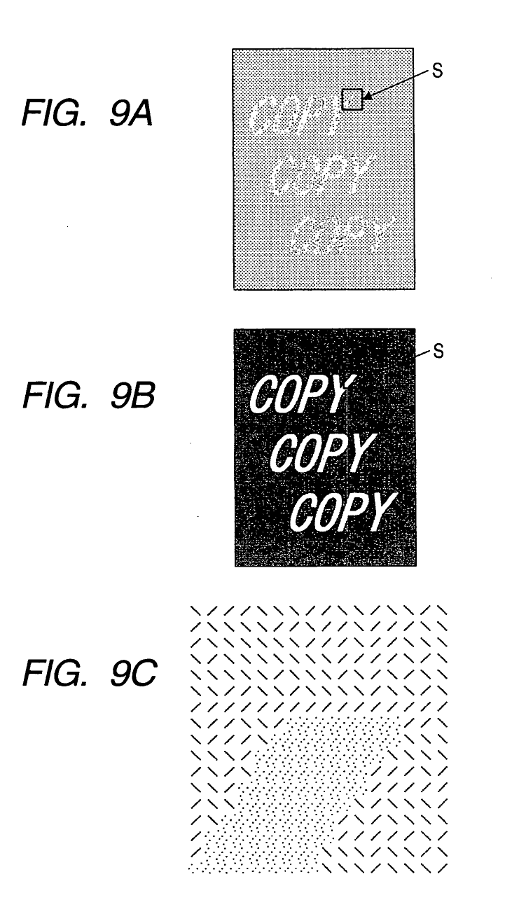

FIGS. 9A to 9C are diagrams showing a printed material on which a background tint block image generated by the image processing device 2 is printed, wherein FIG. 9A shows a printed material on which a background tint block image is printed, FIG. 9B shows a copy manuscript copied from the printed material, and FIG. 9C is a diagram showing the background tint block image achieved by enlarging an area S of FIG. 9A.

As shown in FIGS. 9A and 9B, when the printed material is copied, an area having black pixels in the latent image (an area represented by characters “COPY” in FIGS. 9A and 9B) is printed with white color, and the latent image appears. The characters “COPY” are not perceived by human beings, and it is perceived only if the printed material is copied.

In the background tint block image, plural patterns different in shape are arranged on the basis of the first information, and positional relationship between the adjacent patterns thus arranged is adjusted on the basis of the second information. As shown in FIG. 9C, the printed material has the background tint block image printed thereon, plural patterns different in shape are arranged in the background tint block image on the basis of the first information (first code), and the positional relationship between the adjacent patterns thus arranged is adjusted on the basis of the second information (second code). In this printed material, the area having the black pixels in the latent image corresponds to an isolated dot pattern, and the area having the white pixels in the latent image is any hatched pattern.

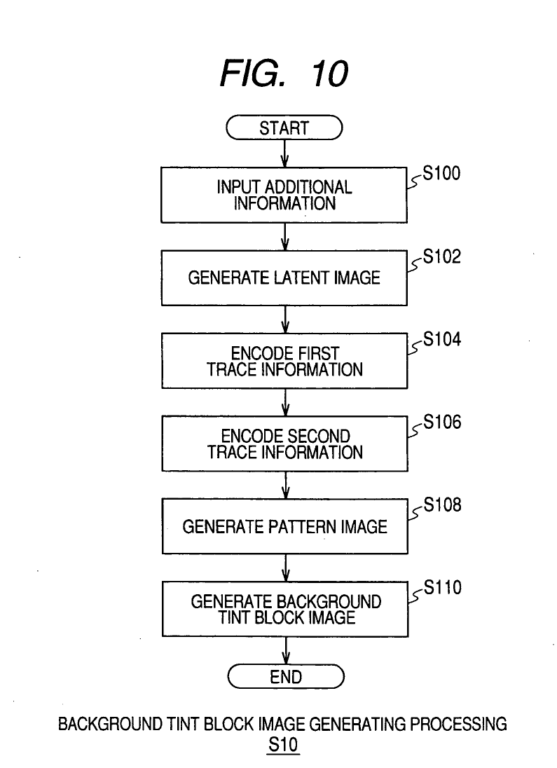

FIG. 10 is a flowchart showing background tint block image generating processing (S10) of the image processing program 4.

As shown in FIG. 10, in step 100 (S100), the tint block image generator 46 inputs additional information (latent image information, first trace information, second trace information) from the controller 40.

In step 102 (S102), the latent image generator 462 of the tint block image generator 46 generates a latent image on the basis of the input latent image information.

In step 104 (S104), the first encoder 460 generates the first code on the basis of the input first trace information, and repetitively arranges the first code to generate the first bit arrangement.

In step 106 (S106), the second encoder 464 generates the second code on the basis of the input second trace information, and repetitively arranges the second code to generate the second bit arrangement.

In step 108 (S108), the pattern image generator 466 generates the pattern image on the basis of the latent image generated by the latent image generator 462, the first bit arrangement generated by the first encoder 460 and the plural patterns which are different in shape from one another and stored in the pattern memory 468.

In step 110 (S110), on the basis of the second bit arrangement generated by the second encoder 464, the pattern position modulator 470 adjusts the positional relationship between the adjacent patterns of the pattern image generated by the patter image generator 466, and generates the background tint block image. The pattern position modulator 470 stores the background tint block image into the tint block image buffer 48.

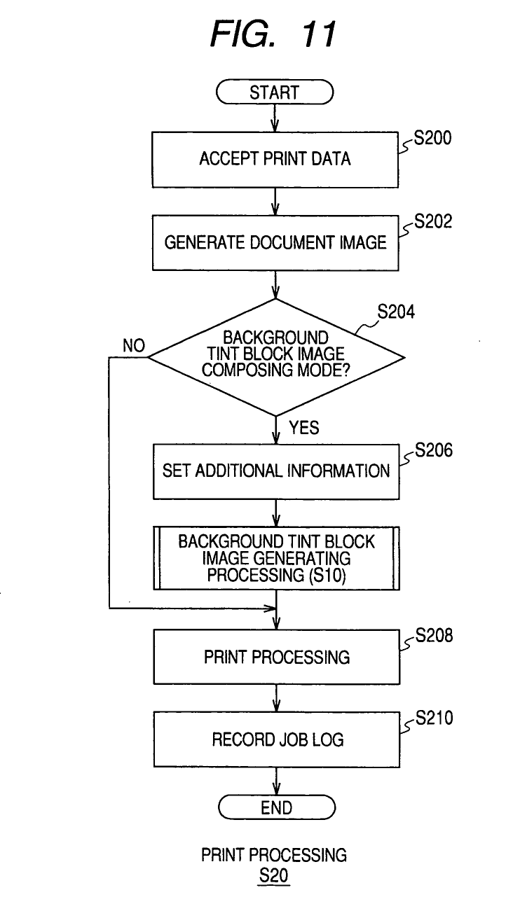

FIG. 11 is a flowchart showing the print processing (S20) of the image forming device 10 according to the exemplary embodiment of the present invention.

As shown in FIG. 11, in step 200 (S200), the image forming apparatus 10 accepts PDL-format document data transmitted from the terminal device 5 through the network 3. The controller 40 of the image processing program 4 outputs the document data concerned to the document image generator 42.

In step 202 (S202), the document image generator 42 interprets PDL and executes the drawing processing on the document data concerned to generate document image data. The document image generator 42 stores the document image data thus generated into the document image buffer 44.

In step 204 (S204), the controller 40 judges whether the background tint block image composing mode is set or not. When the mode concerned is set, the controller 40 goes to the processing of S206. If not so, the controller 40 goes to the processing of S208.

In step 206 (S206), the controller 40 outputs the additional information containing the latent image information, the first trace information and the second trace information to the tint block image generator 46, and the additional information is set in the tint block image generator 46. Thereafter, the background tint block image generating processing (FIG. 10; S10) is executed by the tint block image generator 46, and the background tint block image is generated and stored in the tint block image buffer 48.

In step 208 (S208), when the background tint block image composing mode is set, under the control of the controller 40, the image composer 54 reads out the document image and the background tint block image from the document image buffer 44 and the tint block image buffer 48 respectively in synchronism with the printer 12, combines the document image and the background tint block image and then outputs the composite result to the printer 12. When the background tint block non-composing mode is set, the image composer 54 reads out the document image from the document image buffer 44 in synchronism with the printer 12, and outputs the document image concerned to the printer 12.

In step 210 (S210), the controller 40 associates the first trace information and the document image data with the job log ID (second trace information), and records the first trace information and the document image data as a job log into the memory 204 or the recording device 24 such as a hard disk drive or the like.

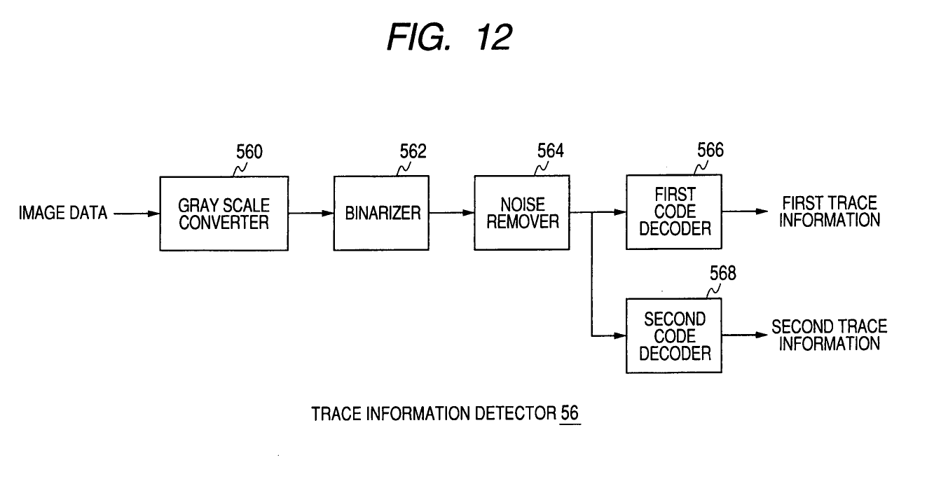

FIG. 12 is a diagram showing the details of the trace information detector 56.

As shown in FIG. 12, the trace information detector 56 contains a gray scale converter 560, a binarizer 562, a noise remover 564, a first code decoder 566 and a second code decoder 568. The trace information detector 56 detects plural patterns contained in the image by the above constituent elements, and detects the information on the basis of the positional relationship between the adjacent patterns of the plural patterns thus detected.

In the trace information detector 56, the gray scale converter 560 accepts image data read by the scanner 14 (for example, RGB color), and carries out the conversion from full color to gray scale. A described above, the gray scale converter 560 constitutes an accepting unit for accepting the read image.

The binarizer 562 conducts the binarization processing on multi-valued image data which has been subjected to the conversion processing to the gray scale by the gray scale converter 560, and generates binary image data.

The noise remover 564 executes noise removing processing on the image data binarized by the binarizer 562, and outputs the noise-removed image data to the first code decoder 566 and the second code decoder 568. The noise remover 564 deletes the latent image from the image data, for example.

The first code decoder 566 detects the first code on the basis of two kinds of hatched patterns contained in the image, and decodes the first code concerned to restore the first trace information.

The second code decoder 568 detects the second code on the basis of the distance of two pattern pairs which are contained in the image and adjacent to each other in the vertical direction, restores the second code and restores the second trace information.

The first code decoder 566 and the second code decoder 568 will be described hereinafter in detail.

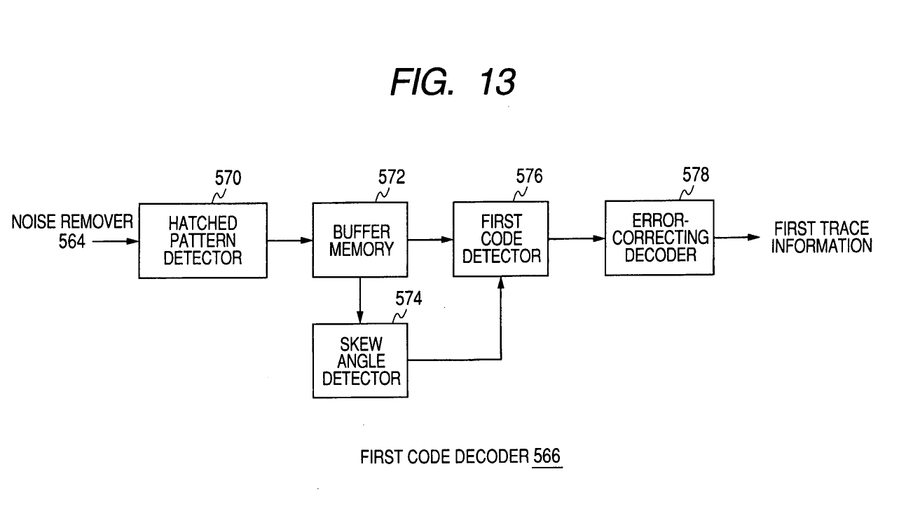

FIG. 13 is a diagram showing the details of the first code decoder 566.

As shown in FIG. 13, the first code decoder 566 contains a hatched pattern detector 570, a buffer memory 572, a skew angle detector 574, a first code detector 576 and an error-correcting decoder 578.

In the first code decoder 566, the hatched pattern detector 570 detects plural patterns that are contained in the accepted read image and different in shape. More specifically, the hatched pattern detector 570 accepts the noise-removed image data, detects the two kinds of hatched patterns and stores the processing result image data into the buffer memory 572. The processing result image data are image data in which one pixel is represented by two bits. In this image data, the pixel value of a position at which the hatched pattern corresponding to the bit 0 is detected is set to zero, the pixel value of a position at which the hatched pattern corresponding to the bit 1 is detected is set to 1, and the pixel values at the other positions are set to 2.

The buffer memory 572 stores the processing result image data detected by the hatched pattern detector 570.

The skew angle detector 574 reads out the image data stored in the buffer memory 572 at a predetermined timing, and calculates a skew angle of the input image data. More specifically, the skew angle detector 574 executes Hough transformation on pixels represented by only the pixel values 0 and 1, and determines the peak of a projection distribution thereof on the angle θ axis to determine the skew angle. The skew angle detector 574 outputs the calculated skew angle to the first code detector 576. The Hough transformation executed by the skew angle detector 574 will be described in detail later.

The first code detector 576 detects the first information (first code) on the basis of the arrangement of the plural patterns detected by the hatched pattern detector 570. More specifically, the first code detector 576 reads out the image data stored in the buffer memory 572 at a predetermined timing, and scans the image along the skew angle determined by the skew angle detector 574 to extract the pixel value corresponding to any one of the bit 0 and the bit 1.

The first code detector 576 detects a synchronous code from the extracted bit array. Here, the synchronous code is generated by the first encoder 460. For example, in the synchronous code, each bit on the outer periphery of a rectangular area having a predetermined size in the longitudinal and lateral directions is set to “1” (FIG. 6A). The first code detector 576 detects a two-dimensional code as a bit arrangement surrounded by the synchronous code on the basis of the detected synchronous code, re-arranges this two-dimensional code to a one-dimensional bit array, and then outputs the re-arranged one-dimensional bit array to the error-correcting decoder 578.

The error-correcting decoder 578 executes predetermined error-correcting decoding processing on the bit array input from the first code detector 576 to decode the first trace information. The error-correcting decoder 578 outputs the decoded first trace information to the controller 40 (FIG. 4).

The characteristic of the Hough transformation executed by the skew angle detector 574 will be described.

The Hough transformation is represented by the following equation:

ρ=x·cos θ+y·sin θ (1)

### Here, θ represents the angle, and ρ represents the distance.

When a point (x, y) on the image is subjected to the Hough transformation, it becomes a sine wave on the transformed space (Hough space). When a point sequence arranged on a line is subjected to the Hough transformation, plural sine waves each of which corresponds to each point concentrate on one point on the Hough space, so that the value of the point concerned is maximum. When a group of points arranged in the grid form is subjected to the Hough transformation, plural groups of sine waves which concentrate on respective one points are arranged in parallel on the Hough space. At this time, all the sine wave groups concentrate on the respective one points at the same angle θ. This angle θ is coincident with the tilt angle of the grid on the image. Furthermore, the interval of the points on which the respective sine wave groups concentrate is coincident with the grid interval of the point group on the grid. Accordingly, by determining the one-point concentrating angle θ and the interval of the concentrated points as described above, the skew angle and interval (period) of the point group can be determined.

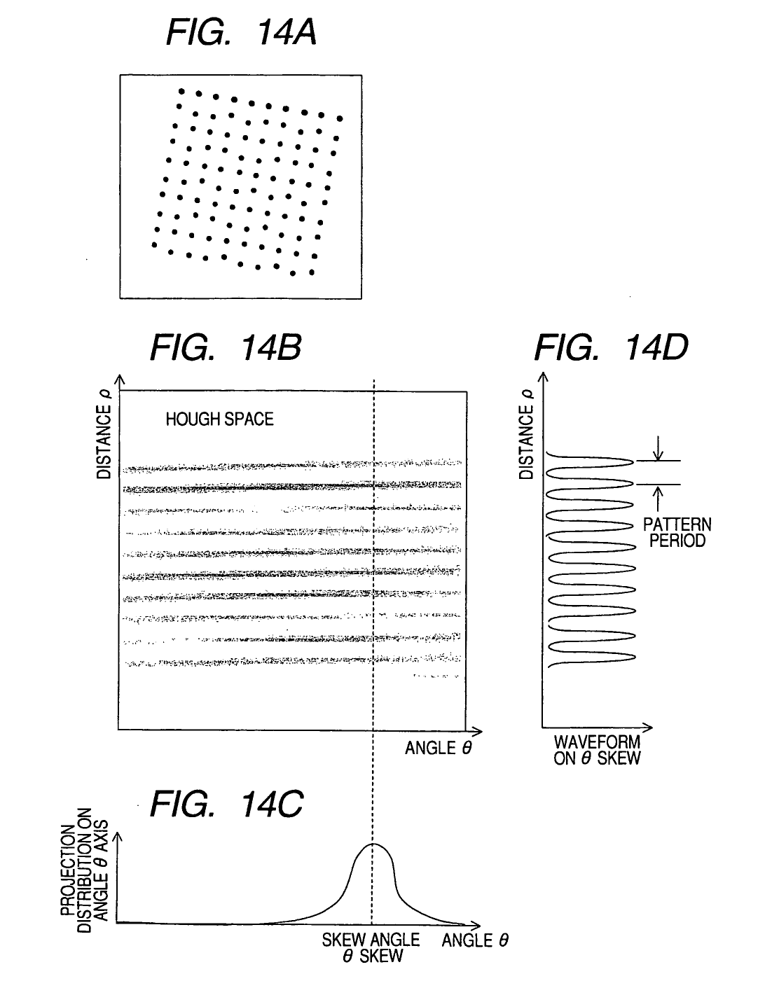

FIGS. 14A to 14D are diagrams showing the Hough transformation executed by the skew angle detector 574. Specifically, FIG. 14A shows image data (pattern data) stored in the buffer memory 572, FIG. 14B shows a Hough space after all the patterns have been subjected to the Hough transformation, FIG. 14C shows a projection distribution on the angle θ axis, and FIG. 14D shows a waveform in a distance ρ direction on the angle θ skew.

As shown in FIG. 14A, plural pattern pixels (pixels whose pixel values are equal to 0 or 1) are contained in the image data stored in the buffer memory 572. The skew angle detector 574 reads out the image data from the buffer memory 572, successively operates the image data from the original point to detect pattern pixels, and execute the Hough transformation on the basis of all the coordinates of the pattern pixels thus detected.

As shown in FIG. 14B, after the Hough transformation on all the patterns is finished, the skew angle detector 574 determines the maximum value of the values of each element on the Hough space. The skew angle detector 574 determines a protection distribution on the θ axis for each element on the Hough space. The projection is carried out while a half of the maximum value is set as a threshold value and elements below the threshold value are set to zero. Accordingly, the projection distribution on the θ axis has a maximum value at some angle θ as shown in FIG. 14C. The skew angle detector 574 sets the angle θ providing the maximum value in the projection distribution as a skew angle θ skew. The skew angle detector 574 outputs the detected skew angle to the first code detector 576.

As shown in FIG. 14D, the waveform in the distance ρdirection on the angle θ skew has some period. Here, when the average of the peak interval is calculated and it is set as a period, this period becomes a period (i.e., interval) of pattern lines on the image (on the real space).

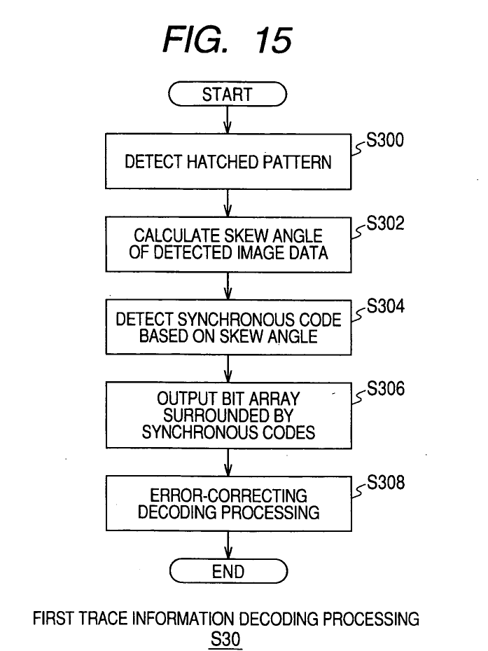

FIG. 15 is a flowchart showing the first trace information decoding processing (S30) performed by the first code decoder 566.

As shown in FIG. 15, in step 300 (S300), noise-removed image data are input to the hatched pattern detector 570, and two kinds of hatched patterns are detected. The processing result image data are stored into the buffer memory 572 by the hatched pattern detector 570.

In step 302 (S302), the image data stored in the buffer memory 572 are read out by the skew angle detector 574, and the skew angle of the image data is calculated by the skew angle detector 574. Specifically, the skew angle detector 574 executes the Hough transformation on pixels whose pixel values are equal to 0 or 1 to calculate the skew angle.

In step 304 (S304), the image data stored in the buffer memory 572 are read out by the first code detector 576. The first code detector 576 scans the image along the calculated skew angle to extract the pixel values corresponding to any one of the bit 0 and the bit 1, and detects the synchronous code from the extracted bit array.

In step 306 (S306), the two-dimensional code is detected by the first code detector 576 on the basis of the detected synchronous code, re-arranges the two-dimensional code to one-dimensional bit array and then outputs the re-arranged one-dimensional bit array to the error-correcting decoder 578.

In step 308 (S308), in the error-correcting decoder 578, predetermined error-correction decoding processing is executed on the bit array input from the first code detector 576 to restore the first trace information.

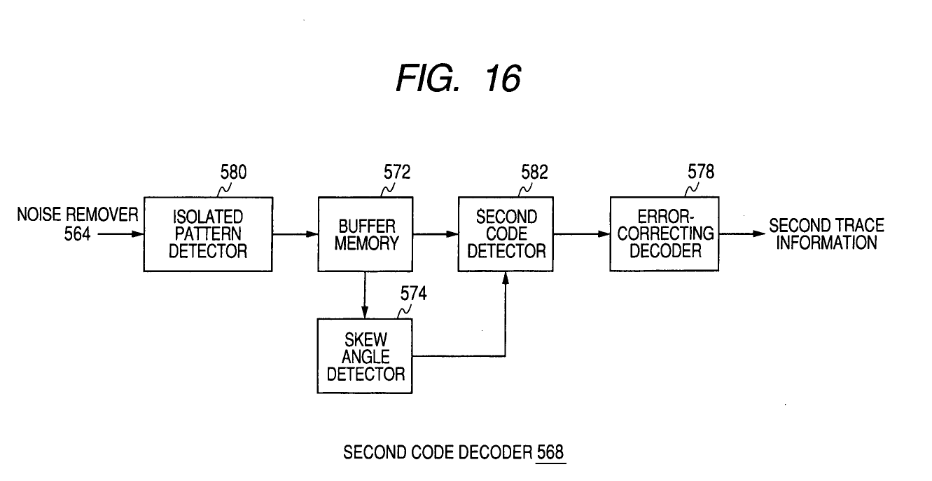

FIG. 16 shows the details of the second code decoder 568.

As shown in FIG. 16, the second code decoder 568 contains an isolated pattern detector 580, a buffer memory 572, a skew angle detector 574, a second code detector 582 and an error-correcting decoder 578. In the construction shown in FIG. 16, substantially the same elements as the construction shown in FIG. 13 are represented by the same reference numerals.

In the second code decoder 568, the isolated pattern detector 580 detects plural patterns contained in an image. More specifically, the isolated pattern detector 580 accepts noise-removed image data, detects isolated patterns each of which has a predetermined area or less, generates pattern center position image data containing the center coordinates of the isolated patterns concerned, and stores the pattern center position image data into the buffer memory 572. Here, with respect to the pattern center position image data, one pixel is represented by one bit, for example, and the pixel values at the positions where the center positions of the isolated patterns are detected are set to 1 while the pixel values at the other positions are set to 0. The shape of the pattern contained in the image is not detected by the isolated pattern detector 580.

The second code detector 582 detects the second information (second code) on the basis of the positional relationship between the adjacent patterns out of the plural patterns detected by the isolated pattern detector 580. More specifically, the second code detector 582 reads out the pattern center position image data stored in the buffer memory 572 at a predetermined timing, calculates the positional relationship between adjacent patterns on the basis of the skew angle determined by the skew angle detector 574, and detects an embedded bit value on the basis of the calculated distance.

When reading out the pattern center position image data, the second code detector 582 searches a pixel which is nearest to the original point in the data concerned and whose pixel value is equal to 1 (i.e., the center of the isolated pattern), and sets the pixel concerned as a starting point. The second code detector 582 searches, from the starting point, pattern center points existing in a predetermined range in a direction perpendicular to the skew angle, and determines the distance between the starting point and each searched pattern center point. When the distance concerned is smaller than a predetermined interval (for example, 12 pixels), the second code detector 582 detects the bit 1, and when the distance concerned is larger than the predetermined interval, the second code detector 582 detects the bit 0.

The second code detector 582 executes the same detection processing at a predetermined interval in the skew angle direction, thereby detecting the position modulation bit array of one line. When the detection processing of the position modulation bit array of one line is finished, the second code detector 582 returns to the starting point, and searches the isolated pattern center at positions which correspond to the double of the predetermined interval (for example, 24 pixels) in the direction perpendicular to the skew angle. The second code detector 582 likewise achieves a second position modulation bit array with the searched position as a new starting point. The second code detector 582 repeats the same processing till the lower end of the image to detect the bit arrays of one image.

The second code detector 582 detects the synchronous code from the detected bit array. Here, the synchronous code is generated by the second encoder 464, and it is designed so that each bit on the outer periphery of a rectangular area having a predetermined size in the longitudinal and lateral directions is set to “1” (FIG. 6B), for example. The second code detector 582 detects a two-dimensional code as a bit array surrounded by the synchronous code on the basis of the detected synchronous code, re-arranged the two-dimension code concerned to a one-dimensional bit array and then outputs it to the error-correcting decoder 578.

The error-correcting decoder 578 executes predetermined error-correcting decoding processing with respect to the bit arrays input from the second code detector 582 to decode the second trace information. The error-correcting decoder 578 outputs the decoded second trace information to the controller 40 (FIG. 4).

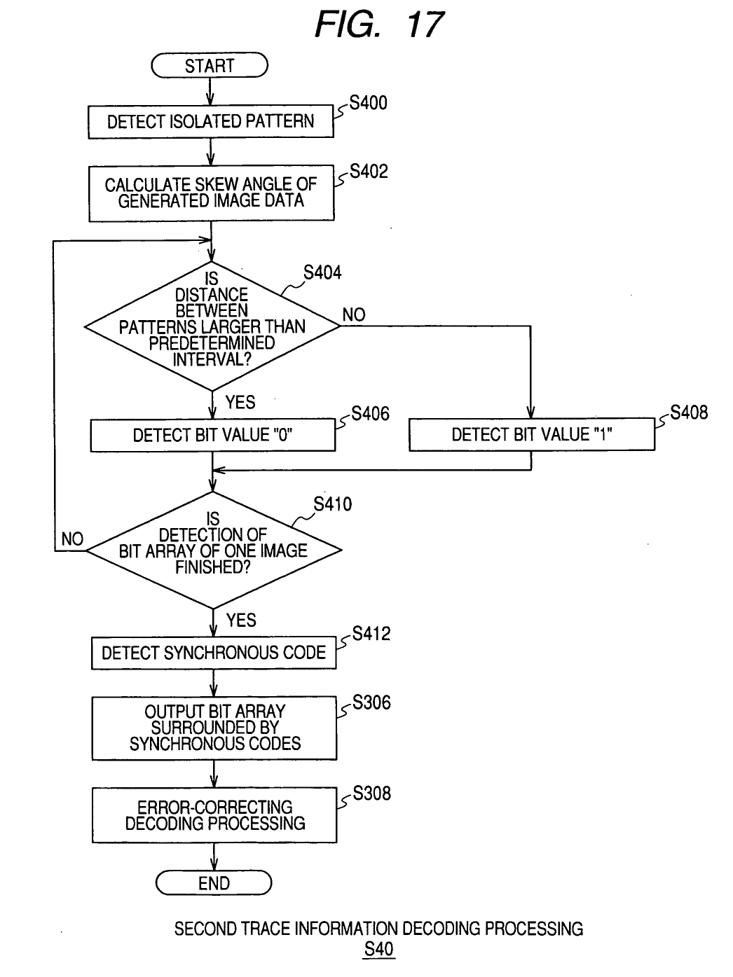

FIG. 17 is a flowchart showing the second trace information decoding processing (S40) by the second code decoder 568. In the respective steps of the processing shown in FIG. 17, substantially the same steps as the processing shown in FIG. 15 are represented by the same reference numerals.

As shown in FIG. 17, in step 400 (S400), noise-removed image data are input to the isolated pattern detector 580 to detect isolated patterns, and pattern center position image data are generated. The pattern center position image data are stored into the buffer memory 572 by the isolated pattern detector 580.

In step 402 (S402), the pattern center position image data stored in the buffer memory 572 are read out by the skew angle detector 574, and the skew angle of the image data concerned is calculated from the skew angle detector 574. Specifically, the skew angle detector 574 executes the Hough transformation on pixels whose pixel values are equal to any one of 0 and 1 to calculate the skew angle.

In step 404 (S404), the pattern position center image data stored in the buffer memory 572 are read out by the second code detector 582. As described above, the second code detector 582 determines the distance between the starting point and the searched pattern center point, and judges whether this distance is larger than a predetermined interval or not. If the distance is larger than the predetermined interval, the second code detector 582 goes to the processing of S406, and if not so, the second code detector 582 goes to the processing of S408.

In step 406 (S406), the second code detector 582 detects the bit 0 on the basis of the position relationship concerned.

In step 408 (S408), the second code detector 582 detects the bit 1 on the basis of the positional relationship concerned.

In step 410 (S410), the second code detector 582 judges whether the bit array of one image is detected or not. If the bit array of one image is detected, the second code detector 582 goes to the processing of S412, and if not so, the second code detector 582 goes to the processing of S404.

Instep 412 (S412), the synchronous code is detected from the detected bit array. Thereafter, in the processing of S306, the two-dimensional code is detected on the basis of the synchronous code by the second code detector 582, re-arranged to the one-dimensional bit array and then output to the error-correcting decoder 578. Furthermore, in the processing of S308, the error-correcting decoder 578 executes the error-correcting decoding processing on the input bit array to decode the second trace information.

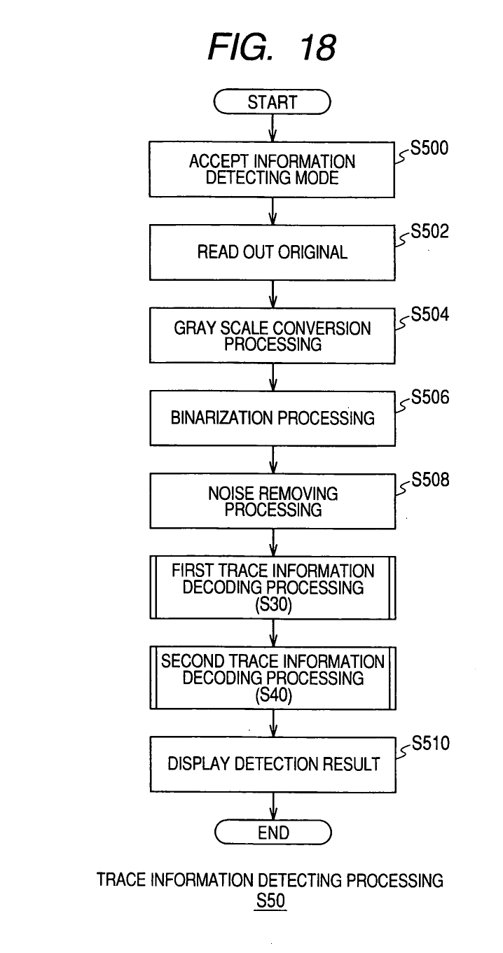

FIG. 18 is a flowchart showing the trace information detection processing (S50) of the image processing device 2 according to the exemplary embodiment of the present invention.

As shown in FIG. 18, in step 500 (S500), the controller 40 of the image processing program 4 (FIG. 4) accepts through the UI device 26 (FIG. 3) an user's operation indicating the setting of information detecting mode for detecting trace information. The setting concerned may be carried out in advance.

In step 502 (S502), when the user puts an original on the platen of the scanner 14 and pushes a copy button, the original is read by the scanner 14. The read image is output to the trace information detector 56 of the image processing program 4 by the scanner 14.

In step 504 (S504), the read image is subjected to conversion processing to a gray scale by the gray scale converter 560 of the trace information detector 56 (FIG. 15).

In step 506 (S506), the multi-valued image data which have been subjected to the conversion processing to the gray scale are subjected to binarization processing by the binarizer 562.

In step 508 (S508), the binary image data which have been subjected to the binarization processing concerned are subjected to the noise-removing processing by the noise remover 564.

The noise-removed image data are output to the first code decoder 566. In the first code decoder 566, the first trace information decoding processing (FIG. 15; S30) is executed to decode the first trace information, and then the first trace information thus decoded is output to the controller 40.

Furthermore, the noise-removed image data are output to the second code decoder 568. In the second code decoder 568, the second trace information decoding processing (FIG. 17; S40) is executed to decode the second trace information, and then the second trace information is output to the controller 40.

When no trace information is detected from the image, this fact is output to the controller 40.

In step 510 (S510), the controller 40 displays the input information detection result on the UI device 26. Furthermore, the controller 40 extracts the job log ID from the detected trace information. When the extracted job log ID concerned exists in the job log data in the image forming device 10, the controller 40 displays the data concerned and the document image data associated with the job log ID concerned or the thumb nail thereof on the UI device 26.

As described above, the image processing device 2 of this exemplary embodiment of the present invention has a code image generating unit for generating a code image which contains plural patterns different in shape and represents predetermined information on the basis of the positional relationship between adjacent patterns, and an image composing unit for combining the code image generated by the code image generating means with a document image. Therefore, according to the image processing device 2, there can be generated an image for which embedded information can be effectively detected even when the image is copied.

Furthermore, the image processing device 2 has a pattern arranging unit for arranging plural patterns different in shape, and a pattern position adjusting unit for adjusting the positional relationship between adjacent patterns arranged by the pattern arranging unit on the basis of predetermined information. Therefore, according to the image processing device 2, information can be embedded in an image so that the information concerned can be effectively detected even when the image is copied.

Particularly, the image processing device 2 arranges patterns on the basis of the first information, and adjusts the positional relationship between adjacent patterns on the basis of the second information. Therefore, according to the image processing device 2, the information is embedded on the basis of the pattern shape and the positional relationship between patterns, and thus the capacity of the information to be embedded can be increased. The image processing device 2 may adjust the distance between patterns adjacent in the vertical direction on the basis of the second information, or the distance between patterns adjacent in the horizontal direction. Therefore, according to the image processing device 2, the information is embedded on the basis of the pattern shape and the distance between the patterns in the vertical direction and the horizontal direction, so that the capacity of the information to be embedded can be further increased.

Furthermore, the image processing device 2 may adjust the positional relationship between adjacent patterns on the basis of the second trace information containing at least a part of the first trace information. Therefore, according to the image processing device 2, the first trace information and the second trace information may be embedded in an image so that at least a part of the first trace information is detected on the basis of the positional relationship between patterns.

The information to be embedded by the image processing device 2 may contain identification information for identifying the composite image. Therefore, according to the image processing device 2, when the embedded information is detected, the image may be uniquely identified.

The image processing device 2 has a pattern detecting unit for detecting plural patterns contained in an image, and an information detecting unit for detecting information on the basis of the positional relationship between adjacent patterns out of the plural patterns detected by the pattern detecting unit. Therefore, according to the image processing device 2, even when an original having information embedded therein is copied, the embedded information may be effectively detected from a copy of the original.

Furthermore, the image processing device 2 has an accepting unit for accepting a read image, a first pattern detecting unit for detecting plural patterns which are contained in the read image accepted by the accepting unit and different in shape, a first information detecting unit for detecting first information on the basis of the arrangement of the plural patterns detected by the first pattern detecting unit, a second pattern detecting unit for detecting the plural patterns contained in the read image accepted by the accepting unit, and a second information detecting unit for detecting second information on the basis of the positional relationship between adjacent patterns out of the plural patterns detected by the second pattern detecting unit. Therefore, according to the image processing device 2, even when an original having information embedded therein is copied, information embedded on the basis of at least positional relationship between the patterns can be detected. Furthermore, information embedded on the basis of the pattern shape and the positional relationship between patterns can be detected.

In the above-described exemplary embodiment, the position of only the lower pattern of each pattern pair is displaced. However, the positions of both the upper and lower pattern of each pair may be displaced. For example, when the bit 0 is embedded, the upper pattern is downwardly displaced by one pixel, and the lower pattern is upwardly displaced by one pixel. When the bit 1 is embedded, both the patterns are displaced in the opposite directions so as to be far away from each other. In this case, when the bit 0 is embedded, the distance between the patterns is relatively shorter by the amount corresponding to two pixels, and when the bit 1 is embedded, the distance between the patterns is relatively longer by the amount corresponding to two pixels.

Furthermore, in the above-described exemplary embodiment, the two patterns adjacent in the vertical direction (up-and-down direction) are paired. However, two patterns adjacent in the horizontal direction (right-and-left direction) may be paired, and disposed so as to be positionally displaced from each other in the horizontal direction. Furthermore, two patterns adjacent in an oblique direction may be paired and disposed so as to be positionally displaced from each other in the oblique direction. Still furthermore, the above-described exemplary embodiment may be modified so that after two patterns adjacent in the vertical direction are paired and information is embedded, two patterns adjacent in the horizontal direction are paired and another information or the same information is embedded.

Furthermore, in the above-described embodiment, binary (1 bit) information is embedded on the basis of the direction in which the patters are positionally displaced from one another. However, multi-valued information may be embedded on the amount of displacement (the distance between patterns)

In the above-described embodiment, patterns having two shapes which vary in the rotational direction are used as the shapes of the patterns. However, patterns having two kinds of shapes such as a round and a rectangle may be used.

Furthermore, the image processing program 4 may not be contained in the image forming device 10, and for example, it may operate on an external server connected to the image forming device 10 through a network. In the above-described exemplary embodiment, an indication as to whether trace information should be embedded at the print time (the background tint block image composing mode) is preset by a manager. However, it may be modified so that a user of the terminal device 5 indicates the mode concerned at the print time and the data indicating that the mode concerned is set is transmitted to the image forming device 10 when print data are transmitted from the terminal device 5 to the image forming device 10. In this case, indication of the background tint block image composing mode and various kinds of necessary additional information may be added to a header of document data (PDL).

Next, the image processing device 2 according to a second exemplary embodiment of the present invention.

The image processing device 2 of this exemplary embodiment is different from the image processing device 2 of the first exemplary embodiment in that plural patterns different in shape and pattern interval are held in advance and the patterns concerned are selected on the basis of the first trace information and the second trace information to generate a pattern image. Furthermore, according to the image processing device 2, when embedded information is detected, the second code is referred to when the first code is detected, and the first code is referred to by the second code is detected, whereby the detection precision of these codes is enhanced.

The image processing device 2 according to this exemplary embodiment is different from the image processing device 2 according to the first exemplary embodiment in that the former image processing device 2 has a tint block image generator 66 in place of the tint block image generator 46 of the image processing program 4 (FIG. 4) and a trace information detector 76 in place of the trace information detector 56.

The tint block image generator 66 and the trace information detector 56 will be described.

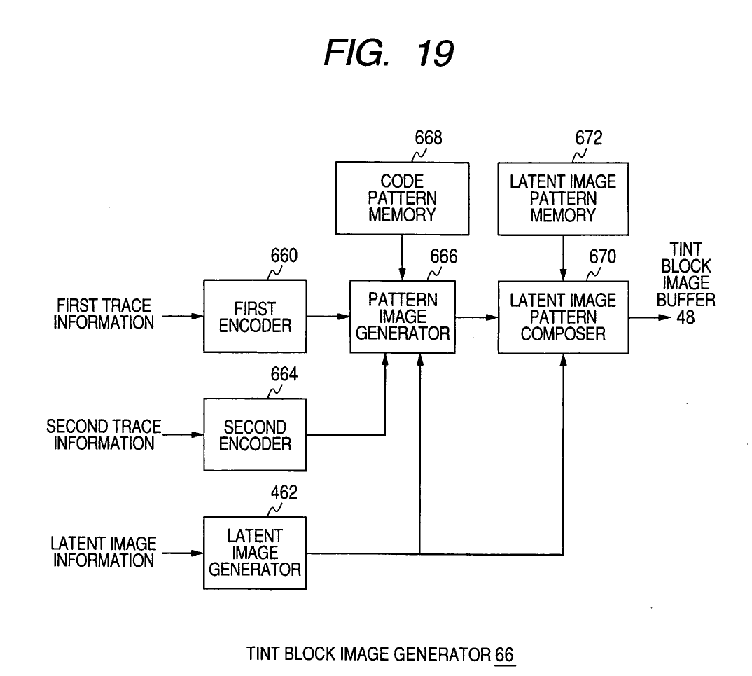

FIG. 19 is a diagram showing the details of the tint block image generator 66.

As shown in FIG. 19, the tint block image generator 66 contains a first encoder 660, a second encoder 664, a latent image generator 462, a pattern image generator 666, a code pattern memory 668, a latent image pattern composer 670 and a latent image pattern memory 672. In the constituent elements shown in FIG. 19, substantially the same elements as the construction shown in FIG. 5 are represented by the same reference numerals. According to this construction, the tint block image generator 66 constitutes a code image generating unit for generating a code image (background tint block image) representing predetermined information on the basis of an arrangement of plural patterns in which sub patterns different in shape are arranged in different positional relationships.

The first encoder 660 executes error-correcting coding on the input first trace information, and divides the bit array after the error-correcting coding to 2-bit based words. The words thus achieved are two-dimensionally arranged to generate a word arrangement (first code) having a predetermined size. Here, the words on the outer periphery of the first code are synchronous codes representing the cut-out position of the first code when information is detected, and all the words are set to “11”, for example. The first encoder 660 generates a first word arrangement having the same size as a latent image generated by the latent image generator 462 by repetitively arranging the first code in the longitudinal and lateral directions. The first encoder 660 outputs the generated first word arrangement to the pattern image generator 666.

The second encoder 664 generates a second code as in the case of the second encoder 464 (FIG. 5). The generated second code has the same size as the first code in the longitudinal and lateral directions because one element is a two-bit word in the first code. The second encoder 664 generates a bit arrangement (second bit arrangement) having the same size as the latent image by repetitively arranging the generated second code in the longitudinal and lateral directions. At this time, the second encoder 664 arranges the second code so as to displace the phase in both the longitudinal and lateral directions by a half of the code, for example. The second encoder 664 outputs the generated second bit arrangement to the pattern image generator 666.

The first word arrangement and the second bit arrangement will be described in detail later.

The pattern image generator 666 generates a pattern image on the basis of the latent image generated by the latent image generator 462, the first word arrangement generated by the first encoder 660, the second bit arrangement generated by the second encoder 664 and a code pattern stored in a code pattern memory 668 as described later. The pattern image generator 666 outputs the generated pattern image to the latent image pattern composer 670. The pattern image generating processing will be described in detail later.

The latent image pattern composer 670 composes a latent pattern stored in the latent image pattern memory 672 (isolated dot pattern of FIG. 7C) in the pattern image on the basis of the pattern image generated by the pattern image generator 666 and the latent image generated by the latent image generator 462. The latent image pattern composer 670 successively refers to each pixel of the latent image from the original point, and when the pixel of the latent image is a black pixel, the latent image pattern is composed at the position corresponding to the pixel concerned in the pattern image.

Here, the latent image is 50 dpi, and the pattern image is 600 dpi, and one pixel of the latent image corresponds to 12 pixels×12 pixels of the pattern image. Therefore, the latent image pattern composer 670 composes the latent image pattern at the portion of 12 pixels×12 pixels of the position corresponding to the pixel concerned in the pattern image. As described above, the latent image pattern composer 670 composes the latent image pattern as described above, thereby generating the background tint block image. The latent image pattern composer 670 stores the generated background tint block image into the tint block image buffer 48.

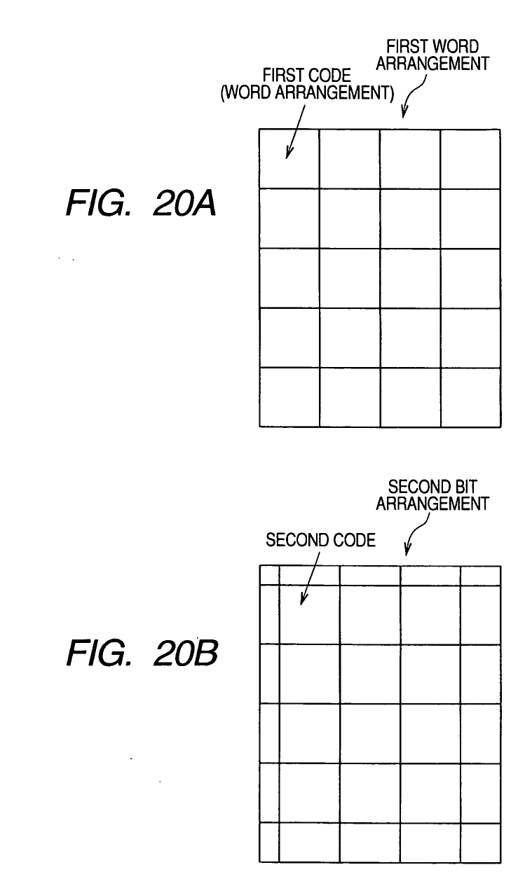

FIGS. 20A and 20B are diagrams showing the first word arrangement and the second bit arrangement. More specifically, FIG. 20A shows the first word arrangement generated by the first encoder 660, and FIG. 20B shows the second bit arrangement generated by the second encoder 664.

As shown in FIG. 20A, the first word arrangement is constructed by arranging the first codes (word arrangement). As shown in FIG. 20B, the second bit arrangement is generated by displacing the phase thereof from that of the first bit arrangement so that the code boundaries (synchronous codes) of the second codes contained in the second bit arrangement are not overlapped with the code boundaries (synchronous codes) of the first codes contained in the first word arrangement.

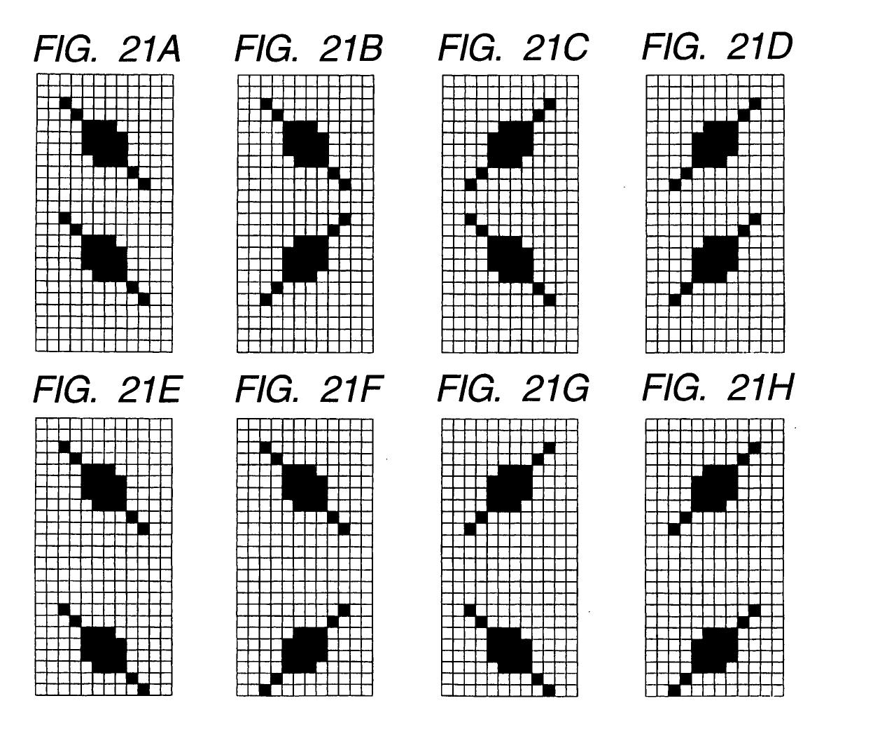

FIGS. 21A to 21H are diagrams showing patterns which are stored in the code pattern memory 668 and referred to by the pattern image generator 666.

As shown in FIG. 21, the patterns are achieved by arranging two kinds of sub patterns different in shape (for example, a hatched pattern of 12 pixels×12 pixels extending to the upper right side and a hatched pattern of 12 pixels×12 pixels extending to the lower right side) in different positional relationships., and for example, it has 12 pixels×24 pixels. There are two kinds of intervals of the two sub patterns contained in the patterns, that is, a large interval (for example, 14 pixels) and a small interval (for example, 10 pixels). Accordingly, each pattern represents information of 3 bits on the basis of the shape of the upper sub pattern, the shape of the lower sub pattern and the distance between sub patterns.

The pattern image generator 666 successively refers to values at the same position from the upper left side for totally 3 bits of the word (2 bits) of the first word arrangement and the bit (1 bit) of the second bit arrangement and selects any one of the patterns (FIGS. 21A to 21H) stored in the code pattern memory 668 on the basis of the value of 3 bits and the pixel value of the latent image to generate the pattern image. For example, the pattern image generator 666 combines 2 bits of the first word arrangement and 1 bit of the second code while the 2 bits of the first word arrangement is set as a lower bit and the 1 bit of the second code is set as the most significant bit, thereby calculating the value of 3 bits, and selects the pattern on the basis of the calculated value and the pixel value of the latent image.

Here, when the latent image is a white pixel and the value of the 3-bit pair is equal to zero, the pattern shown in FIG. 21A is selected.

### When the latent image is a white pixel and the value of the 3-bit pair is equal to 1, the pattern shown in FIG. 21B is selected.

When the latent image is a white pixel and the value of the 3-bit pair is equal to 2, the pattern shown in FIG. 21C is selected.

When the latent image is a white pixel and the value of the 3-bit pair is equal to 3, the pattern shown in FIG. 21D is selected.

When the latent image is a white pixel and the value of the 3-bit pair is equal to 4, the pattern shown in FIG. 21E is selected.

When the latent image is a white pixel and the value of the 3-bit pair is equal to 5, the pattern shown in FIG. 21F is selected.

When the latent image is a white pixel and the value of the 3-bit pair is equal to 6, the pattern shown in FIG. 21G is selected.

When the latent image is a white pixel and the value of the 3-bit value is equal to 7, the pattern shown in FIG. 21H is selected.

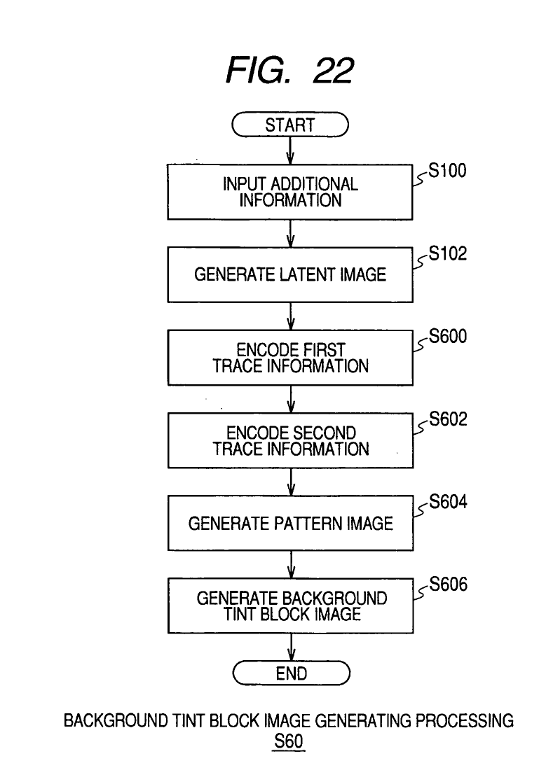

FIG. 22 is a flowchart showing the background tint block image generating processing (S60) of the image processing program 4 operating on the image processing device 2 according to the exemplary embodiment. In the respective steps of FIG. 22, substantially the same processing as shown in FIG. 10 are represented by the same reference numerals.

As shown in FIG. 22, when the tint block image generator 66 inputs additional information (latent image information, first trace information, second trace information) from the controller 40 in the processing of S100, the latent image generator 462 of the tint block image generator 66 generates the latent image on the basis of the latent image information in the processing of S102.

In step 600 (S600), the first encoder 660 generates the word arrangement (first code) on the basis of the input first trace information, and repetitively arranges the first code to generate the first word arrangement.

In step 602 (S602), the second encoder 664 generates the second code on the basis of the input second trace information, and repetitively arranges the second code to generate the second bit arrangement. At this time, the second encoder 664 arranges the second codes so that the phase of the second code is displaced from the phase of the first word arrangement.

In step 604 (S604), the pattern image generator 666 selects a code pattern stored in the code pattern memory 668 on the basis of the latent image generated by the latent image generator 462, the first word arrangement generated by the first encoder 660 and the second bit arrangement generated by the second encoder 664, and generates a pattern image.

In step 606 (S606), when the pixel in the latent image generated by the latent image generator 462 is a black pixel, the latent image pattern composer 670 composes a latent image pattern at the position corresponding to the black pixel concerned in the pattern image. As described above, the latent image pattern composer 670 generates the background tint block image and stores it into the tint block image buffer 48.

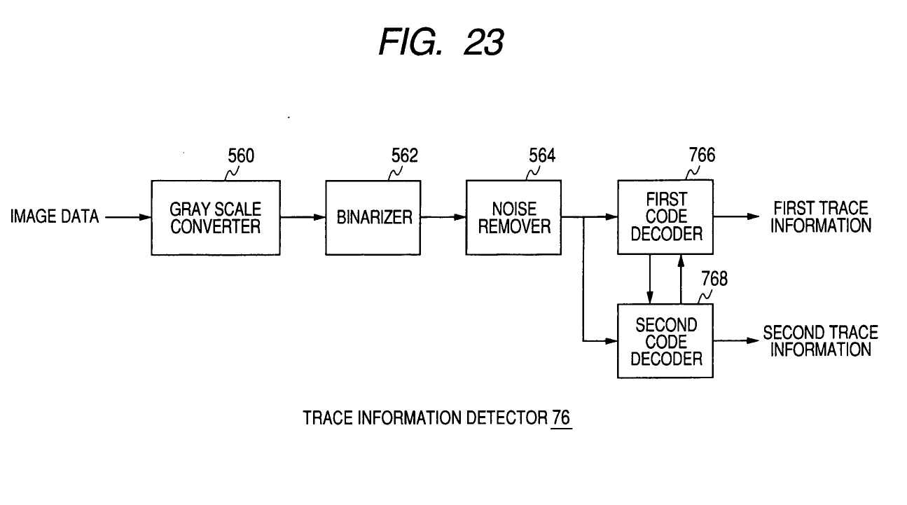

FIG. 23 is a diagram showing the details of the trace information detector 76.

As shown in FIG. 23, the trace information detector 76 contains a gray scale converter 560, a binarizer 562, a noise remover 564, a first code decoder 766 and a second code decoder 768. In the constituent elements shown in FIG. 23, substantially the same elements as the construction of FIG. 12 are represented by the same reference numerals.

The trace information detector 76 is different from the trace information detector 56 shown in FIG. 12 in that it executes the synchronous code detecting processing and the decoding processing on the basis of the information output from the second code decoder 768 again when the first code decoder 766 fails in the decoding, and executes the synchronous code detecting processing and the decoding processing on the basis of the information output from the first code decoder 766 again when the second code decoder 768 fails in the decoding.

In the trace information detector 76, the first code decoder 766 detects the first code on the basis of the two kinds of hatched patterns contained in the image, and decodes the first code to decode the first trace information. Furthermore, the first code decoder 766 outputs the position information of the detected first code to the second code decoder 768. When the first code decoder 766 cannot properly decode the first trace information, it refers to the position information of the detected second code input from the second code decoder 768 and executes the code detecting processing again. The first code and the second code are arranged so as to be displaced in phase by a predetermined amount. Therefore, the first code decoder 766 further detects the first code on the basis of the position information of the detected second code and the displacement in phase of the predetermined amount.

The second code decoder 768 detects the second code on the basis of the distance between two paired patterns adjacent in the vertical direction which are contained in the image, and decodes the second code concerned to thereby decode the second trace information. Further, the second code decoder 768 outputs the position information of the detected second code to the first code decoder 766. Furthermore, when the second code decoder 768 cannot properly decode the second trace information, the second code decoder 768 refers to the detection position information of the first code input from the first code decoder 766, and executes the detecting processing of the second code again further on the basis of the detection position information of the first code and the displacement in phase of the predetermined amount.

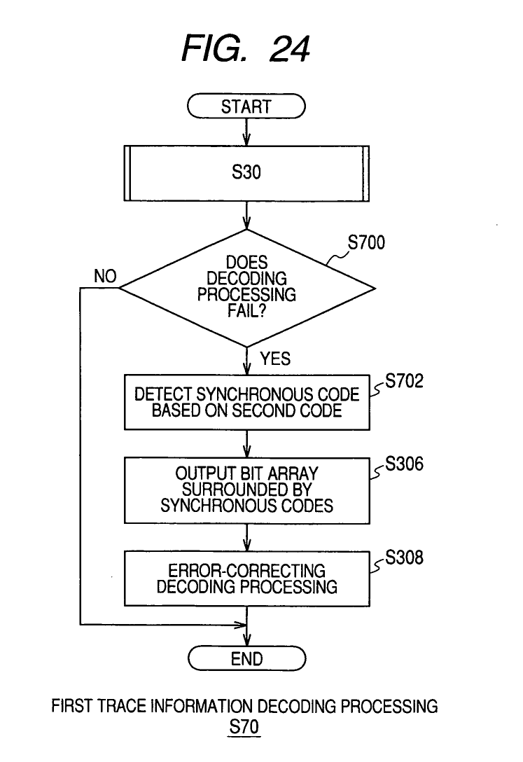

FIG. 24 is a flowchart showing the first trace information decoding processing (S70) of the first code decoder 766. In the steps shown in FIG. 24, substantially the same steps as the processing as shown in FIG. 15 are represented by the same reference numerals.

As shown in FIG. 24, when noise-removed image data are input, the two kinds of hatched patterns is detected in the processing of S30 (FIG. 15), the skew angle is determined, the synchronous code and the two-dimensional code are detected, and the first trace information is decoded.

In step 700, the first code decoder 766 judges whether the decoding processing fails. If the decoding processing succeeds, the first code decoder 766 finishes the processing. If the decoding processing fails, the first code decoder 766 goes to S702.

In step 702, the first code decoder 766 refers to the detection position information of the second code input from the second code decoder 768, and executes the code detecting processing again to detect the synchronous codes.

The first code decoder 766 detects the bit arrangement surrounded by the synchronous codes in the processing of S306, and executes the error-correcting decoding processing in S308 to decode the first trace information.

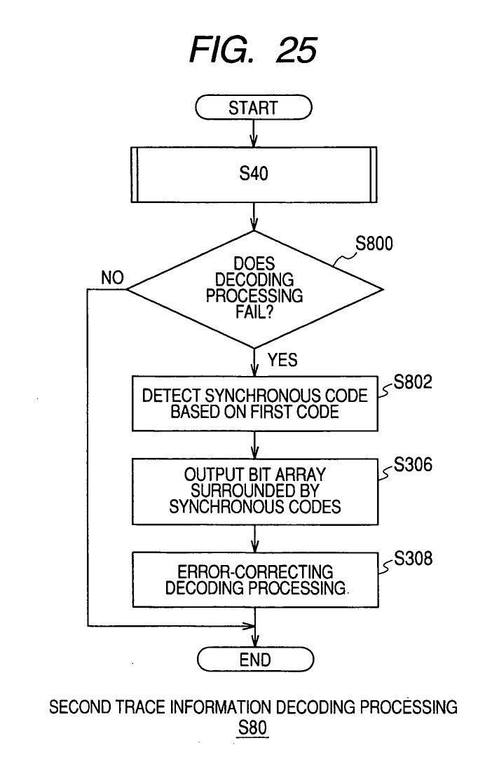

FIG. 25 is a flowchart showing the second trace information decoding processing (S80) of the second code decoder 768. In the steps of FIG. 25, substantially the same steps as the processing shown in FIG. 17 are represented by the same reference numerals.

As shown in FIG. 25, when noise-removed image data are input, the second trace information is decoded in the processing of S40 (FIG. 17).

In step 800, the second code decoder 768 judges whether the decoding processing fails or not. If the decoding processing succeeds, the second code decoder 768 finishes the processing, and if the decoding processing fails, the second code decoder 768 goes to the processing of S802.

In step 802, the second code decoder 768 refers to the detection position information of the first code input from the first code decoder 766, and executes the code detection processing again to detect synchronous codes. In the processing of S306, the second code decoder 768 detects a bit arrangement surrounded by the synchronous codes, and executes the error-correcting decoding processing in the processing of S308 to decode the second trace information.

As described above, the image processing device 2 according to this exemplary embodiment has a code image generating unit for generating a code image representing predetermined information on the basis of an arrangement of plural patterns in which plural sub patterns different in shape are arranged in different positional relationships, and an image composing unit for combining the code image generated by the code image generating unit and the document image. Accordingly, the image processing device 2 can flexibly embed information which can be effectively detectable even when an image is copied in the image.

Furthermore, the image processing device 2 detects the first information further on the basis of the second information detected by the second code decoder 768, and detects the second information further on the basis of the first information detected by the first code decoder 766. Accordingly, the image processing device 2 can more accurately detect the first code and the second code.

Particularly, even in a case where a document character array is overlapped with the position of a synchronous code of the first code in accordance with the content of a document image with which a background tint block image is combined and thus the synchronous code of the first code at the position concerned is not detected, if the second code displaced from the first code by the amount corresponding to a half code is detected, the position of the first code is determined on the basis of the position of the second code, and thus the first code can be detected. Accordingly, the image processing device 2 can surely detect the embedded trace information irrespective of the content of the document image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing device comprising:
a code image generating unit that generates a code image that contains a plurality of patterns different in shape and represents predetermined information on the basis of positional relationship between adjacent patterns; and
an image composing unit that combines the code image generated by the code image generating unit and a document image to generate a composed image.

2. The image processing device according to claim 1, wherein the code image generating unit comprises:
a pattern arranging unit that arranges a plurality of patterns different in shape, and
a pattern position adjusting unit that adjusts the positional relationship between adjacent patterns arranged by the pattern arranging unit on the basis of predetermined information.

3. The image processing device according to claim 2, wherein:
the pattern arranging unit arranges the patterns on the basis of first information, and
the pattern position adjusting unit adjusts the positional relationship between adjacent patterns on the basis of second information.

4. The image processing device according to claim 3, wherein the pattern position adjusting unit adjusts the positional relationship between the adjacent patterns on the basis of the second information containing at least a part of the first information.

5. The image processing device according to claim 2, wherein the pattern position adjusting unit adjusts the distance between patterns adjacent in a vertical direction.

6. The image processing device according to claim 2, wherein the pattern position adjusting unit adjusts the distance between patterns adjacent in a horizontal direction.

7. The image processing device according to claim 1, wherein the predetermined information includes identification information for identifying the composed image composed by the image composing unit.

8. An image processing device comprising:
a code image generating unit that generates a code image representing predetermined information on the basis of an arrangement of a plurality of patterns in which a plurality of sub patterns different in shape are arranged in different positional relationships; and
an image composing unit that combines the code image generated by the code image generating unit and a document image.

9. An image processing device comprising:
a pattern detecting unit that detects a plurality of patterns contained in an image;
an information detecting unit that detects information on the basis of positional relationship between adjacent patterns out of the plurality of patterns detected by the pattern detecting unit.

10. An image processing device comprising:
an accepting unit that accepts a read image;
a first pattern detecting unit that detects a plurality of patterns that are contained in the read image accepted by the accepting unit and are different in shape;
a first information detecting unit that detects first information on the basis of arrangement of the plurality of patterns detected by the first pattern detecting unit;
a second pattern detecting unit that detects a plurality of patterns contained in the read image accepted by the accepting unit; and
a second information detecting unit that detects second information on the basis of positional relationship between adjacent patterns out of the plurality of patterns detected by the second pattern detecting unit.

11. The image processing device according to claim 10, wherein the first information detecting unit detects the first information further on the basis of the second information detected by the second information detecting unit.

12. The image processing device according to claim 10 wherein the second information detecting unit detects the second information further on the basis of the first information detected by the first information detecting unit.

13. An image forming device comprising:
a code image generating unit that generates a code image that contains a plurality of patterns different in shape and represents predetermined information on the basis of positional relationship between adjacent patterns;
an image composing unit that combines the code image generated by the code image generating unit and a document image to compose a composite image;
an output unit that outputs the composite image formed by the image composing unit.

14. An image forming device comprising:
a code image generating unit that generates a code image that contains a plurality of patterns different in shape and represents predetermined information on the basis of positional relationship between adjacent patterns;
an image composing unit that combines the code image generated by the code image generating unit and a document image to compose a composite image;
an output unit that outputs the composite image composed by the image composing unit;
a reading unit that reads an image output from the output unit;
a pattern detecting unit that detects a plurality of patterns contained in the read image; and
an information detecting unit that detects information on the basis of positional relationship between adjacent patterns out of the plurality of patterns detected by the pattern detecting unit.

15. A tint block image comprising a plurality of patterns that are different in shape and arranged on the basis of first information, wherein:
the positional relationship between adjacent patterns out of the arranged patterns is arranged on the basis of second information.

16. A printed material having a tint block image printed thereon, the tint block image comprising a plurality of patterns that are different in shape and arranged on the basis of first information, wherein positional relationship between adjacent patterns out of the arranged patterns is arranged on the basis of second information.

17. An image processing method comprising:
generating a code image that contains a plurality of patterns different in shape and represents predetermined information on the basis of positional relationship between adjacent patterns; and
combining the code image thus generated and a document image.

18. An image processing method comprising:
generating a code image representing predetermined information on the basis of an arrangement of a plurality of patterns in which a plurality of sub patterns different in shape are arranged in different positional relationships; and
combining the generated code image and a document image.

19. An image processing method comprising:
detecting a plurality of patterns contained in an image;
detecting information on the basis of positional relationship between adjacent patterns out of the detected plurality of patterns.

20. An image processing method comprising:
accepting a read image;
detecting a plurality of patterns that are contained in the accepted read image and different in shape;
detecting first information on the basis of an arrangement of the detected plurality of patterns;
detecting a plurality of patterns contained in the accepted read image; and
detecting second information on the basis of positional relationship between adjacent patterns out of the detected plurality of patterns.

21. An image processing method comprising:
generating a code image that contains a plurality of patterns different in shape and represents predetermined information on the basis of positional relationship between adjacent patterns;
combining the generated code image and a document image to compose a composite image;
outputting the composite image;
reading a document image;
detecting a plurality of patterns contained in the read document image; and
detecting information on the basis of positional relationship between adjacent patterns out of the detected plurality of patterns.

22. An image forming method comprising:
generating a code image that contains a plurality of patterns different in shape and represents predetermined information on the basis of positional relationship between adjacent patterns;
combining the generated code image and a document image to compose a composite image; and
outputting the composite image.

23. A computer readable medium storing a program causing a computer to execute a process for image processing, the process comprising:
generating a code image that contains a plurality of patterns different in shape and represents predetermined information on the basis of positional relationship between adjacent patterns; and
combining the generated code image and a document image.

24. A computer readable medium storing a program causing a computer to execute a process for image processing, the process comprising:
generating a code image for representing predetermined information on the basis of an arrangement of a plurality of patterns in which a plurality of sub patterns different in shape are arranged in different positional relationships; and
combining the generated code image and a document image.

25. A computer readable medium storing a program causing a computer to execute a process for image processing, the process comprising:
accepting a read image;
detecting a plurality of patterns that are contained in the accepted read image and different in shape;
detecting first information on the basis of an arrangement of the detected plurality of patterns;
detecting a plurality of patterns contained in the accepted read image;
detecting second information on the basis of positional relationship between adjacent patterns out of the detected plurality of patterns.

26. A computer readable medium storing a program causing a computer to execute a process for image processing, the process comprising:
generating a code image that contains a plurality of patterns different in shape and represents predetermined information on the basis of positional relationship between adjacent patterns;
combining the generated code image and a document image to compose a composite image; and
outputting the composite image.

27. A recording medium recorded with a program making a computer of an image forming device execute:
generating a code image that contains plural patterns different in shape and represents predetermined information on the basis of positional relationship between adjacent patterns;
combining the generated code image and a document image to compose a composite image;
outputting the composite image;
reading a document image;
detecting plural patterns contained in the read document image; and
detecting information on the basis of positional relationship between adjacent patterns out of the detected plurality of patterns.
